(19) United States
(12) Patent Application Publication
(10) Pub. No.: US 2004/0210940 A1
(43) Pub. Date: Oct. 21, 2004

(54) Method for improving ranging frequency offset accuracy

(76) Inventors: Punit Shah, Tucker, GA (US); Russell Crisp, Suwanee, GA (US)

Correspondence Address: ARRIS INTERNATIONAL, INC, 3871 LAKEFIELD DRIVE, SUWANEE, GA, 30024, US

(21) Appl. No.: 10/827,155

(22) Filed: Apr. 19, 2004

Related U.S. Application Data
(60) Provisional application No. 60/463,566, filed on Apr. 17, 2003.

(51) Int. Cl. H04N 7/173; H04L 1/02; H04B 7/10

(52) U.S. Cl. 725/111; 725/105; 725/121

(57) ABSTRACT

An frequency offset message generated by a CMTS is applied by a cable modem to the actual frequency to which it is currently tuned. Quantizing error, or truncation error, occurs only once, since the offset is determined based on the actual tuned frequency. The frequency offset message is converted into a digital offset word—giving rise to quantizing error—and is then applied to another digital word that represents the currently tuned frequency.

Thus, the maximum error bound is one half of the frequency value corresponding to a frequency word change of the least significant bit. The result of applying the offset word to the current frequency word results in a new frequency word, which the cable modem retains until another frequency offset message is received and used as a basis for another frequency offset adjustment.

### CROSS REFERENCE TO RELATED APPLICATION

This application claims the benefit of priority under 35 U.S.C. 119(e) to the filing date of Shah, et. al., U.S. provisional patent application No. 60/463,566 entitled “Cable Modem Ranging Frequency Offset Accuracy”, which was filed Apr. 17, 2003, and is incorporated herein by reference in its entirety.

### FIELD OF THE INVENTION

The present invention relates generally to broadband communication networks, and more particularly to improving the accuracy with which a broadband device at a subscriber location tunes to a broadband communication channel center frequency.

### BACKGROUND

In a communication network, a sending device and a receiving device typically have processes and protocols for connecting to and sending information data and for interpreting received information data. Networks typically transmit and receive electrical or optical signals where the electrical characteristics of a signal varies according to the information it is carrying. For example, in a cable modem/CMTS network, known to those skilled in the art, a cable modem receives an instruction from the CMTS instructing it to tune to a certain upstream channel. This command is typically included in an upstream channel change descriptor (“UCD”), known in the art. It will be appreciated that this message is received and processed internally as double precision frequency value.

When the cable modem receives this command, it attempts to tune to a frequency for upstream transmission that corresponds to the commanded frequency. However, the cable modem uses a chipset, such as, for example, a TNETC 4401 Data Over Cable Service Interface Specification (“DOCSIS”) chipset marketed by Texas Instruments, Inc. that converts the commanded frequency value into a digital word that is used to program the frequency inside the modem. As with any digital system, the resolution, in this case the frequency resolution, with which the modem can actually tune depends on the number of bits in the digital word. The tunable frequencies also depend on the clock frequency of the modem's internal clock. Accordingly, the frequency tuned to in response to a tuning command is a product of the bit resolution and the clock frequency. The finest frequency increment that can typically be adjusted when tuning is given as clock frequency divided by the possible number of different frequencies that can be commanded based on the word size.

For example, if, as in the case of the TNETC 4401 chip set, a cable modem's internal crystal frequency is 25 MHz, the clock multiplier is 7 and the digital frequency tuning word size is 24 bits, the smallest incremental change in tuning frequency that could be obtained is (7×25×10⁶)/2²⁴=10.43081284 Hz. This is equivalent to the frequency change represented by a change in the digital 24-bit by the least significant bit (LSB).

Although it is possible that the frequency desired by the CMTS for the cable modem to tune to may correspond to a whole number multiple (between 0 and 2²⁴) of 10.43081 HZ, it can also correspond to a frequency value that falls between, for example, 6,123,461.194 Hz and 6,123,450.763 Hz. These frequencies correspond to command hex word values of 8F52F and 8F52E, respectively. Thus, if the desired frequency is not a whole number multiple of the 10.43081 Hz, the cable modem would tune to a frequency corresponding to the nearest matching frequency that is a whole number multiple of 10.43081 Hz.

For example, if the desired frequency is 6,123,456 Hz, the modem would tune to 6,123,461.194 Hz, because 6,123,456 is closer to 6,123,461.194 than to 6,123,450.763 Hz. Accordingly, it will be appreciated that the value tuned to and the desired frequency value can differ by a truncation error 6 up to a value, in hertz, that equates to ½ of the amount that corresponds to a difference in one LSB of the command frequency message contained in the UCD. Thus, the actual value tuned to F′₁ is the commanded frequency F₁±δ₁. The value of ½ LSB corresponds to a value in hertz of approximately 5.194 Hz.

Currently, a CMTS may send a ranging offset message during normal operation after the modem tunes to the nearest matching frequency F′₁ (that is closest to the desired frequency as discussed above), instructing the modem to adjust the frequency it has tuned to by an offset amount ΔF. This may be for a variety of reasons, including drift due to temperature change affecting the modems internal crystal frequency generator. Thus, this desired new frequency is the previously (or currently) tuned actual frequency F′₁ plus or minus the offset frequency ΔF, depending on whether the new frequency desired by the CMTS is higher or lower, respectively, than the frequency currently commanded.

The new frequency desired by the CMTS is referred to as F₂ and the actual frequency that can be tuned to is F′₂, where F′₂=F₂±δ₂; δ₂ being the truncation error of ±½ LSB for the new frequency based on the LSB resolution as discussed above. Since the standard method currently used in the art offsets the frequency relative to the previously commanded frequency F₁ rather than the actual programmed frequency F′₁, the actual offset frequency ΔF using this standard method is F′₂-F′₁. Accordingly, it will be appreciated that the worst case truncation error in hertz corresponds to a difference of ±1 LSB. As discussed above, this equates to a frequency deviation of 10.43081 Hz with the TNETC 4401 chipset. The current DOSCIS standard is that the maximum allowed frequency deviation of the actual tuned frequency from the commanded frequency is 10 Hz. Thus, there is a need in the art for a method that facilitates reducing the error of tuning to a new desired frequency based on an offset ranging frequency command such that the tuning error is less than 10 Hz.

### SUMMARY

A method for reducing the offset ranging frequency to below 10 Hz adds the ranging frequency offset (ΔF) to the frequency to which the modem, or other communication device, is actually tuned. Thus, instead of adding the offset amount ΔF to the frequency command that resulted in the current frequency tuned to, thereby generating a 1 LSB error bound, as discussed above, the improved method results in error being bounded by ½ LSB, because only one truncation error δ is involved in the frequency tuned to.

When the CMTS senses the actual frequency tuned to by a cable modem, it determines the frequency offset ΔF based on the actual frequency tuned to by the modem. Thus, when the communication device, such as, for example, a cable modem, receives a message from the CMTS commanding that it offset its tuning by ΔF, it offsets the actual frequency tuned to by ΔF. For a 24 bit tuning command word scheme, this new frequency F₂ value is quantized, which results in rounding the new frequency up or down to the incremental matching frequency that is the closest multiple of 10.43081 Hz. The new actual frequency F′₂ is bounded as shown by the following:

F′₂=F₂±δ₂, where F₂ and δ₂ are the desired frequency and the truncation error, or quantization error, associated with this new actual frequency F′₂. Thus, the actual ranging offset is

$$\begin{matrix}{F}_{2}^{′} - {F}_{1}^{′} = ( {F}_{2} + \text{/} - {δ}_{3} ) - {F}_{1}^{′} \\ = ΔF + \text{/} - {δ}_{2}\end{matrix}$$

Accordingly, since the actual tuned-to frequency F′₁ is used to determine the offset amount ΔF, and ΔF is added to the actual tuned-to frequency F′₁, the truncation error for the new tuned-to frequency is only ½ LSB rather than 1 LSB, as is the case when the ranging offset is applied to the currently commanded frequency F₁ rather than the frequency actually tuned to F′₁. This method may also be applied to other two-way communication systems and devices, such as, for example, wireless devices such as ellular telephones and PDA's.

### BRIEF DESCRIPTION OF THE DRAWINGS

FIG. 1 illustrates a flow diagram for an improved method for applying a ranging offset to a currently tuned frequency.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. This disclosure is not intended nor is to be construed to limit the present invention or otherwise to exclude other embodiments, adaptations, variations, modifications and equivalent arrangements, the present invention being limited only by the claims appended hereto and the equivalents thereof.

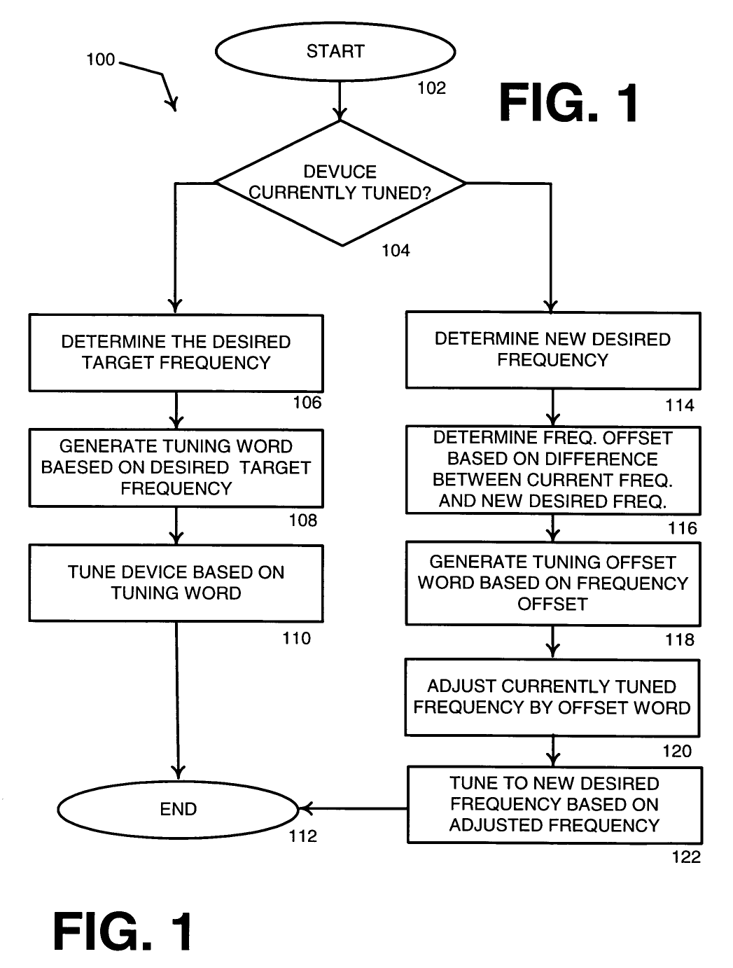

Turning now to the figures, FIG. 1 illustrates a flow chart for a method 100 for increasing the accuracy of applying a ranging offset frequency used to command a communication to device to tune from a currently tuned frequency to a new frequency. The method begins at step 102 when the device, a modem in the preferred embodiment, although other devices such as, for example, a wireless PDA or cellular phone, boots up. As the modem is performing its ranging operation, ranging being known in the art, with another device being communicated with. This other device may be a cable modem termination system (“CMTS”) known in the art, for example. The CMTS determines whether the modem is currently tuned to an upstream frequency at step 104. If not, process 100 proceeds to step 106, where the CMTS determines the desired frequency for the modem or other device to tune. The desired frequency, F₁ is sent in a message to the modem, the messaging and protocol used therefore being known in the art. At step 108, this desired frequency message is digitized into a tuning frequency word F′₁.

The tuning word typically comprises 24 bits, with each possible value represented by the digital word corresponding to a frequency value or increment. For example, if the tuning word is 000000000000000000000001, then, converting to decimal numbering, the frequency corresponding to 1 is 10.43081 Hz, based on a clock frequency of 25 MHz and a clock multiplier of 7, as discussed above. It follows that 000000000000000000000010 corresponds to 20.86163, 000000000000000000000011 corresponds to 31.29243, and so on. It will be appreciated that unless the desired frequency F₁ is exactly a whole number multiple of 10.43081 Hz, there will be a truncation error δ₁ associated when representing the desired frequency digitally with the tuning word.

After the digital tuning word has been determined by the device, the frequency corresponding to the value represented by the tuning word is determined at step 110 and is used to tune the modem, or other communication device, to said frequency. As discussed above, it will be appreciated that the actual frequency tuned to may not match the desired frequency because of the digitizing error, δ, associated with the number of bits in the tuning word. After the device has been tuned to the frequency represented by the tuning word, method 100 ends at step 112. If at step 104 it is determined that the modem or other device is already tuned to a frequency, but the CMTS, or other centrally located equipment, desires that the frequency should be changed, the new frequency is determined at step 114. The CMTS may desire to change the channel to which a particular modem is assigned for a variety of reasons, including thermal drift. When the new desired frequency has been determined, the CMTS evaluates the currently tuned frequency based not on the previously determined desired frequency F₁, but on the actual frequency F′₁ to which the device is currently tuned.

From this actual frequency F′₁, the CMTS determines at step 116 a frequency offset ΔF that, when applied to the current actual frequency F′₁, will tune the modem or other device to the new desired frequency F₂. It will be appreciated that when this frequency offset ΔF is digitized at step 118 into an offset word, using a 24 bit word to represent the frequency value of the offset ΔF, a quantizing error δ₂ will most likely occur, unless the offset frequency ΔF corresponds to a whole number multiple of 10.43081 Hz. 10.43081 Hz corresponds to a scheme using a 24 bit word length with a 25 MHz crystal and a times-7 multiplier as discussed above.

It will also be appreciated that δ₂ (as well as δ₁, which corresponds to the quantizing error bound for the amount the actual currently tuned frequency deviates from the corresponding desired frequency) may be as high as the frequency value corresponding to ½ LSB, or 5.21541 Hz for the 24 bit, 25 MHz times 7 multiplier scheme. However, the actual δ may be less if the desired frequency, or frequency offset, lies somewhere other than exactly halfway between the increment points corresponding to word values differing by one LSB.

At step 120, the modem adjusts the currently tuned frequency by the the frequency corresponding to the offset word generated at step 118, and tunes to the new desired frequency at step 122. The adjustment at step 120 may be implemented by adding or subtracting—depending on whether the new desired frequency is higher or lower than the currently tuned frequency—the absolute value of the offset word determined at step 118 to/from the word corresponding to the currently tuned frequency. This word corresponding to the currently tuned frequency may have been determined at step 108 following initial boot-up of the modem, or other device, or at a previous iteration of step 120. The current frequency word will typically reside in an internal register of the modem until cleared and replaced by a new tuning frequency word, as determined at step 120.

Thus, when the modem tunes to the new desired frequency by applying the digitized ΔF to the currently tuned frequency at step 122, because ΔF was calculated based on the actual currently tuned frequency F′1, rather than the currently desired frequency F1, any truncation error δ₁ has been accounted for and the maximum truncation error for the offset tuning is only ½ LSB. Since this error maximum corresponds to 5.21541 Hz, which is lower than the 10 Hz specified in DOCSIS, an improvement is realized that enhances the performance of a cable modem, or other device, that typically tunes to a frequency based on a digitized representation of a desired frequency. Method 100 ends at step 112.

It will be appreciate that in the foregoing description, δ is referred to as an absolute bounding value, but δ may be either positive or negative, depending on whether the desired frequency is lower or high, respectively, than the nearest whole number multiple of 10.43081 Hz.

It will also be appreciated that instead of the CMTS determining a new, or different, frequency for communicating with a given cable modem than the one it previously determined as desirable, the cable modem, or other device, may have drifted from a frequency desired by the CMTS. Thus, the CMTS may need to cause the cable modem to adjust its upstream frequency for continued efficient communication therewith. Accordingly, application of the frequency offset as described above will cause the cable modem to adjust its upstream frequency for maximum matching between cable modem frequency and CMTS frequency.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

We claim:

1. A method for increasing the ranging offset resolution/accuracy of a communication device attempting to adjust its upstream frequency to which it is currently tuned to match a desired frequency, comprising:
determining a frequency offset based on the difference between the actual currently tuned frequency and the desired frequency;
digitizing the frequency offset into a frequency offset word; and
tuning the communication device by adjusting the actual currently tuned frequency by the frequency value corresponding to the frequency offset word.

2. The method of claim 1 wherein the frequency offset word is applied to a currently tuned frequency word.

3. The method of claim 2 wherein the currently tuned frequency word resides in the communication device.

4. The method of claim 1 wherein the communication device is a cable modem.

5. The method of claim 1 wherein digitizing the frequency offset results in truncation, or quantization error, and wherein the truncation error is stored.

6. The method of claim 5 wherein the stored truncation error is used to facilitate generating the frequency offset message if the offset word is to be applied to the currently commanded frequency instead of the actual frequency.

7. The method of claim 1 wherein the desired frequency is a new frequency with respect to a most recently commanded frequency.

8. A method for increasing the ranging offset resolution/accuracy of a cable modem attempting to adjust its upstream frequency to which it is currently tuned to match a desired frequency, comprising:
determining at a CMTS the actual upstream transmission frequency of the cable modem;
determining at the CMTS a frequency offset based on the difference between the actual currently tuned frequency and the desired frequency;
digitizing the frequency offset into a frequency offset word; and
tuning the device by adjusting the actual currently tuned frequency by the frequency value corresponding to the frequency offset word.

9. The method of claim 8 wherein the frequency offset word is applied to a currently tuned frequency word.

10. The method of claim 9 wherein the currently tuned frequency word resides in the communication device.

11. The method of claim 8 wherein digitizing the frequency offset results in truncation, or quantization error, and wherein the truncation error is stored.

12. The method of claim 11 wherein the stored truncation error is used to facilitate generating the frequency offset message if the offset word is to be applied to the currently commanded frequency instead of the actual frequency.

13. A method for reducing the upstream tuning error of a cable modem that receives a ranging frequency offset from a CMTS, the method comprising updating a software load of the cable modem with software that includes steps for adjusting the current upstream carrier frequency of the modem such that the actual adjusted frequency tuned to, based on the frequency offset, is bounded by only one truncation error instead of two with respect to the desired frequency.

14. The method of claim 13 wherein the updated software load further comprises:
determining at a CMTS the actual upstream transmission frequency of the cable modem;
determining at the CMTS a frequency offset based on the difference between the actual currently tuned frequency and the desired frequency;
digitizing the frequency offset into a frequency offset word; and
tuning the device by adjusting the actual currently tuned frequency by the frequency value corresponding to the frequency offset word.

15. The method of claim 13 wherein the frequency offset word is applied to a currently tuned frequency word.

16. The method of claim 15 wherein the currently tuned frequency word resides in the communication device.

17. The method of claim 14 wherein digitizing the frequency offset results in truncation, or quantization error, and wherein the truncation error is stored.

18. The method of claim 17 wherein the stored truncation error is used to facilitate generating the frequency offset message if the offset word is to be applied to the currently commanded frequency instead of the actual frequency.
